(19) United States
(12) Patent Application Publication
(10) Pub. No.: US 2025/0271332 A1
(43) Pub. Date: Aug. 28, 2025

(54) TEST BENCH FOR A TURBOMACHINE

(71) Applicant: SAFRAN AERO BOOSTERS, Herstal (BE)

(72) Inventors: Anthony Denis Serge WEBER, Herstal (BE); Jérôme MORHET, Herstal (BE)

(21) Appl. No.: 18/858,083

(22) PCT Filed: Apr. 20, 2023
(86) PCT No.: PCT/EP2023/060221

§ 371 Date: Oct. 18, 2024

(30) Foreign Application Priority Data
Apr. 20, 2022 (BE) 20225289

(51) Int. Cl. G01M 15/10; G01M 15/02; G01M 15/14; G01N 33/00

(52) U.S. Cl. CPC G01M 15/102; G01M 15/02; G01M 15/14; G01N 33/0037; G01N 33/004

(57) ABSTRACT

A test bench for a turbomachine comprising an upstream sensor measuring the quantity of particles in the air upstream of an installation zone of the turbomachine; a downstream sensor measuring the quantity of particles in the air downstream of the installation zone; and a calculation unit operating a difference between the quantity of particles downstream and the quantity of particles upstream.

### CROSS-REFERENCE TO RELATED APPLICATIONS

The present invention is the US national stage under 35 U.S.C. § 371 of International Application No. PCT/EP2023/060221 which was filed on Apr. 20, 2023, and which claims the priority of application BE2022/5289 filed on Apr. 20, 2022, the contents of which (text, drawings and claims) are incorporated here by reference in their entirety.

### FIELD

The invention relates to the field of turbomachines and more particularly to test benches for aircraft turbojets.

### BACKGROUND

Certification operations in the aeronautics field are often complex due to the nature of the equipment to be certified and the standards that must be followed.

Thus, the certification of a new turbomachine model requires the turbomachine to be placed on a test bench and a standardized operating cycle to be carried out during which various measurements are made. The International Civil Aviation Organization requires (Annex 16 volume II of the “Standards and Recommended Practices”) in particular the measurement of pollutant emissions (Nox, CO2, CO, fine particles (nvPM), HC, SOx, etc.) and the establishment of an emissions map in a plane perpendicular to the axis of rotation of the turbomachine. FIGS. 1a-d illustrate an example of such a map. This map is obtained using a probe located downstream of the exhaust nozzle of the turbomachine. The probe samples an air flow that is subdivided into several flows, each of the flows reaching different sensors and/or filters. It is thus possible to measure different pollutants in a non-intrusive manner. The probe is successively moved to measure the emissions at various locations.

The air flow at the outlet of the turbomachine is at a high speed and temperature. Such instrumentation is complex to implement and is expensive. Not all test benches are therefore equipped with it.

However, it may be interesting to measure the pollutant emissions of a turbomachine during its operation, and therefore after its certification. Since the constraints linked to certification no longer apply at the stage of regular maintenance checks, it is possible to imagine using a simpler system there, giving a lower level of detail.

There is therefore a need to develop simpler and less expensive instrumentation design for the purpose of regular monitoring of pollutant emissions from a turbomachine.

### SUMMARY

The invention aims to propose an instrumentation allowing the measurement of the emissions of a turbomachine during its life cycle, in a simple and inexpensive manner. The invention also aims to propose the corresponding measurement method.

The invention relates to a test bench comprising an installation zone of a turbomachine, wherein the bench comprises an upstream sensor measuring the quantity of particles in the air upstream of the installation zone; a downstream sensor measuring the quantity of particles in the air downstream of the installation zone; and a calculation unit operating a difference between the quantity of particles downstream and the quantity of particles upstream.

Such a device makes it possible to measure the emissions produced by the turbomachine in a simple way. Since the high level of detail required for certification is no longer essential for routine checks, it is not problematic to measure emissions globally without establishing a detailed map.

According to an advantageous embodiment of the invention, the bench comprises an air inlet chimney and an air outlet chimney, the installation area being arranged in a corridor arranged between the chimneys. According to an advantageous embodiment, the upstream sensor is arranged in the inlet chimney and/or the downstream sensor is arranged in the outlet chimney. This allows an overall measurement of the flow at a good distance from the turbomachine.

According to an advantageous embodiment of the invention, the particles measured by the sensors are: fine particles; Nox; CO; and/or CO2. The fine particles can be nvPM (“non-volatile particulate matter”). It is understood that other particles, polluting or not, can also be detected according to the same principles, for example HC, SOx, etc.

Measured emissions can be expressed as quantity of particles (number, rate, mass, etc.) per unit of air flow (m3, kg, m3/s, etc.) and/or per unit of time.

The invention also relates to a method for measuring the level of emissions of a turbomachine, remarkable in that it comprises a step of placing the turbomachine in the installation zone of a bench according to one of the embodiments above, and a step of operating the turbomachine during which the calculation unit monitors the difference between the quantity of downstream particles and the quantity of upstream particles.

According to an advantageous embodiment of the invention, the operating step consists of imposing an operating cycle with different engine speeds on the turbomachine and of drawing up, via the calculation unit, a correlation between the engine speeds and the quantity of particles emitted.

In various instances, the turbomachine is used at different speeds for sufficient durations to smooth out the effects attributable to inter-speed transient phases.

According to an advantageous embodiment of the invention, the calculation unit determines an average emission during the operating step.

The invention also relates to a method for monitoring the condition of a turbomachine, remarkable in that it comprises the repetition of the method according to one of the embodiments above, at different times during the life of the turbomachine.

According to an advantageous embodiment of the invention, the method comprises repeating the above method for several comparable turbomachines, and recording the data from all the turbomachines in a common database.

“Comparable turbomachines” means turbomachines of the same type or of a design sufficiently similar that they are expected to have similar pollutant emission behavior over their entire service life.

According to an advantageous embodiment of the invention, the method comprises a step of interpolating the emissions measured during the lifespan of the turbomachines to determine a correlation between any given moment in the lifespan of a turbomachine and the average emission of pollutants produced at that given moment.

By monitoring several turbomachines, it is indeed possible to establish a law linking the number of hours in operation of a turbomachine with pollutant emissions. During the lifespan of a turbomachine, it is observed that its emissions can increase regularly. An abnormally high increase can be the sign of unusual deterioration.

According to an advantageous embodiment of the invention, when a turbomachine exhibits measured emissions which exceed by more than 20% the average emission correlated at that moment of its service lifespan, the turbomachine is overhauled, scrapped or is inspected to look for deterioration.

The invention also relates to a method for monitoring the condition of a turbomachine, remarkable in that it comprises the method according to one of the embodiments set out above as well as a step of analysis, diagnosis, or action to identify/control a turbomachine whose pollutant emissions would be higher than a regulatory threshold or a threshold established by correlation between the pollutant emissions and a deterioration of the turbomachine.

The regulatory threshold may be a legally defined threshold.

Actions to be taken may include inspection, repair, removal from service, etc.

The correlation can be established after sufficient data has been collected to establish a cause-effect link between increased emissions and, for example, actual deterioration of a component or the engine.

### DRAWINGS

FIGS. 1a-1d represent the product of a known method: an example of mapping obtained by a movable probe.

FIG. 2 shows a test bench according to the invention.

FIG. 3 shows an example of results obtained with the bench of the invention.

FIG. 4 shows a method according to the invention.

### DETAILED DESCRIPTION

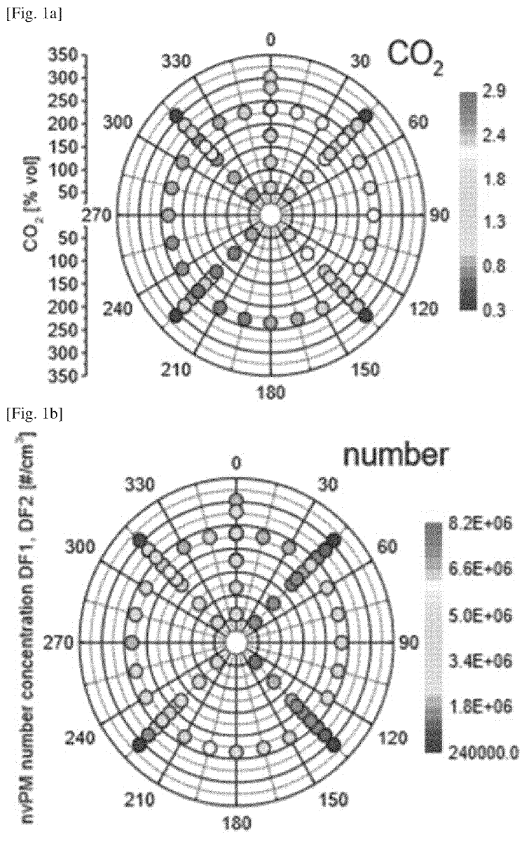

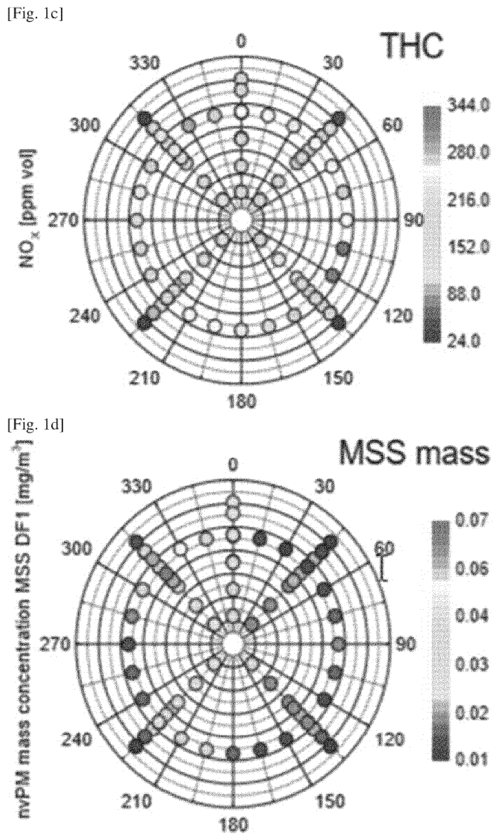

FIGS. 1a-d show illustrations of maps of several types of emissions for the certification of a turbomachine. These maps are obtained by a probe which is successively moved to different points of a plane perpendicular to the axis of the turbomachine (denoted 19 in FIG. 2) and which carries out a point measurement there.

These figures illustrate well the complexity of the procedure to be carried out. The degree of detail required makes it possible to validate an engine architecture. The different positions used for the measurements make it possible to avoid a measurement error that could be linked to a single and inappropriate position of the probe.

During routine maintenance, while it may be useful to obtain an idea of the level of pollution in the turbomachine, a comparable level of detail would be superfluous and such a procedure would unnecessarily extend the downtime of the turbomachine and the costs incurred.

The invention therefore proposes instrumentation such as that shown in FIG. 2. This figure represents in a simplified manner an engine test bench 2, more particularly a test bench 2 for an aircraft turbojet 4. The test bench 2 could possibly receive a complete aircraft, or at least part of an aircraft.

The test bench 2 forms a construction with an infrastructure. It comprises an air passage 6 with an inlet 8 and an outlet 10. The passage 6 comprises an essentially elongated corridor 12. Its length may be greater than or equal to 60 m. The length of the corridor 12 allows the circulation of a laminar air flow 14.

In order to limit the resistance to flow through the corridor 12, in particular the resistance opposing the entry of an air flow 14 into the turbomachine 4, the corridor 12 may have a passage section greater than or equal to 50 m2. The air flow 14 passing through the test bench 2 may be driven by the turbomachine 4 itself during its test phase. An installation zone 16 for the turbomachine 4 is provided. The installation zone 16 may be provided with a fixing system 18 to which the turbomachine 4 is fixed during its test. The system 18 may extend vertically from the ceiling of the corridor 12, in the manner of a column or a post. The system 18 makes it possible to mount the turbomachine 4 with an offset, and to center the latter relative to the middle of the corridor 12, in particular relative to a central axis 19 of the corridor 12.

The corridor 12 can be delimited by vertical chimneys 20, 22 at the inlet 8 and outlet 10. They allow air intake and exhaust, both vertical and elevated relative to the corridor 12. To reduce noise pollution, they can include sound baffles 24, or acoustic blades 24, making it possible to absorb sound waves passively.

The “U” configuration shown in FIG. 2 is a non-limiting example of the general shape of the test bench.

Additional devices 26 may be present at the inlet 8 and outlet 10 to avoid flow inversions, which would disrupt the test conditions. The device 26 at the bench outlet may also be equipped with decontamination means such as those described in document WO 2021/009226 A1.

At the junction between the upstream chimney and the corridor 12, the bench 2 is equipped with a series of deflection blades 28. They make it possible to return the air descending from the inlet chimney 20 in a horizontal direction. At the entrance to the corridor 12, the bench 2 optionally has a grid 30 making it possible to intercept debris likely to disturb the test and damage the turbomachine 4.

To deflect the flow from the exhaust, a cone 32 can be arranged at the right of the outlet chimney 22, fixed to a vertical wall at the end of the corridor 12. Its tip can coincide with the central axis 19.

In order to determine the pollutant emissions of the turbomachine 4, the bench 2 comprises an upstream sensor 34, arranged in the passage 6 upstream of the turbomachine and a downstream sensor 36 arranged downstream of the turbomachine.

The sensors 34, 36 measure a level of particles (for example fine particles nvPM; Nox; CO; CO2, HC, SOx, etc.). The sensors 34 and 36 may be identical. It is understood that the term “sensor” is to be understood in its broad sense: the sensors 34 and 36 may be measurement units that return a signal representative of the quantity of one or more components among those mentioned above; each sensor 34, 36 may also be composed of several detectors arranged at several locations on the bench to locally and/or independently measure one or more quantities of particles.

The upstream sensor 34 measures the pollution rate in the air flow before it flows into the turbomachine 4. The downstream sensor 36 measures the pollution rate in the air flow after it has flowed into the turbomachine 4.

The sensors 34, 36 are connected to a computing unit 38 by a wired or wireless connection. The computing unit 38 thus perceives signals corresponding to a quantity of particles upstream “Pam” and downstream of the turbomachine “Pav”. The computing unit 38 performs a difference D of the measurements of the two sensors (D=Pav−Pam) to deduce therefrom the contribution of the turbomachine to the pollution of the air leaving the turbomachine.

The sensors 34, 36 are schematically illustrated in FIG. 2 at exemplary but non-limiting positions.

In order to limit the measurement uncertainties inherent in inappropriate positioning of the sensors, and in order to provide a global measurement of the phenomena involved, the sensors 34, 36 may be placed at a sufficient axial distance (along the axis 19) from the turbomachine 4. This distance may be at least 10 meters or at least three times the length of the turbomachine.

If the discussion focuses on the two sensors, upstream and downstream, it is understood that the invention can also involve only one sensor downstream of the turbomachine. Thus, to evaluate the level of pollution attributed to the turbomachine, it will be possible, (1) either to assume that the upstream air does not contain polluting particles and to deduce that all of the particles detected by the sensor 36 are to be attributed to the turbomachine, (2) or to carry out a reference measurement of the quality of the ambient air before the turbomachine is put into operation.

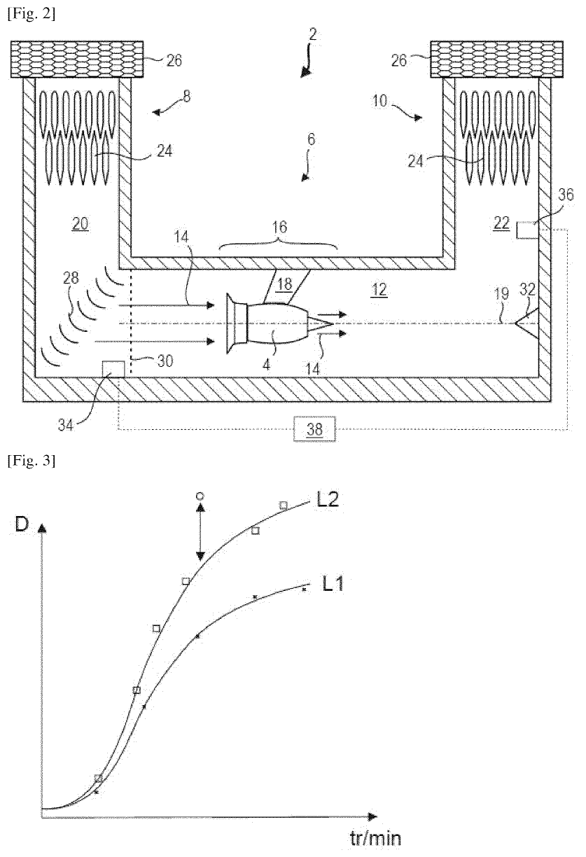

FIG. 3 shows an example of a result that can be obtained with the test bench of the invention. By varying the engine speed and measuring the quantity of a particular pollutant, it is possible to record measurement points. The crosses represent the measurements obtained for a turbomachine at one point in its service life and the squares represent the measurements for the same turbomachine at a later point in its service life. It is thus possible to draw up an L1 law and an L2 law of the relationship between the engine speed and the level of expected pollutants, for each of the particles measured and at each stage of the service life of the turbomachine.

If a measurement (circle on the graph) is carried out on a comparable turbomachine at time L2 of its service life, and the value recorded is very different from the expected L2 curve, it can be concluded that the turbomachine in question is abnormally deteriorated. The threshold deviation that can determine scrapping or a repair or inspection action can be for example 20% of the expected value on the L2 curve.

The test bench of the invention makes it possible to obtain a bundle of curves for different pollutants as a function of the engine speed and as a function of the age of the turbomachine. We therefore obtain, by interpolation of the curves L1 and L2 (and Ln, n>2), a surface in a three-dimensional coordinate system. It is thus possible to know, for any engine speed and at any age of the turbomachine, the pollutants that it is normal to detect.

The bench can also calculate average pollution for a standardized cycle, average pollution which can be used as a reference, instead of, or in addition to, the engine speed curves.

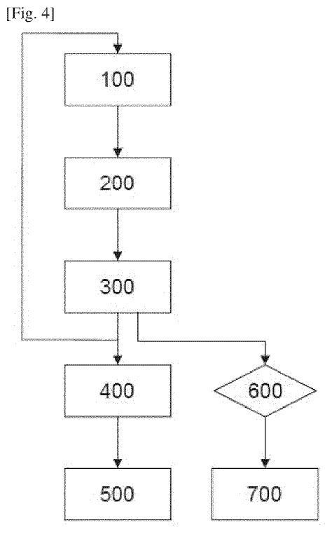

FIG. 4 illustrates a method according to the invention.

The method begins with the installation 100 of a turbomachine 4 in the test bench 2. In step 200, the turbomachine follows an operating cycle which can be composed of different stages at different engine speeds, and different accelerations or decelerations. In step 300, the calculation unit 38 determines the correlation between each pollutant and the engine speed (a curve of the type illustrated in FIG. 3).

These three steps are repeated at several times during the life of the turbomachine to monitor any deviation from a normal progression of pollutant emissions and/or to establish behavior laws.

The three steps 100 to 300 are also repeated for other comparable turbomachines, i.e. of the same type or having similar behavior in terms of pollutant emissions.

The different curves are recorded in a common database at step 400.

Multiple test benches can form a test bench network, each with access to this common database.

Consolidated average values for several comparable turbomachines can be determined in step 500. Interpolations thus make it possible to determine expected values for each pollutant at any time during the service life of a turbomachine. An expected average pollution level and an expected pollution level for each of the particles can thus be defined, at each age of the turbomachine, and at each engine speed.

The results obtained in step 300 can be compared to the expected results drawn up in step 500. If too large a deviation is detected (such as the example of the circle in FIG. 3) in step 600, then the machine in question is scrapped in step 700 or is inspected 700 so as to detect the component(s) of the turbomachine which require repair action.

1.-11. (canceled)

12. A test bench having an installation zone of a turbomachine, wherein the bench comprising:
an upstream sensor measuring the quantity of particles in the air upstream of the installation zone;
a downstream sensor measuring the quantity of particles in the air downstream of the installation zone; and
a calculation unit operating a difference between the quantity of downstream particles and the quantity of upstream particles.

13. The test bench according to claim 12, wherein said bench further comprises an air inlet chimney and an air outlet chimney, the installation zone being arranged in a corridor arranged between the chimneys, the upstream sensor being arranged in the inlet chimney and/or the downstream sensor being arranged in the outlet chimney.

14. The test bench according to claim 12, wherein the particles measured by the sensors are: fine particles; Nox; CO; and/or CO2.

15. A method for measuring the level of emissions of a turbomachine, wherein said method comprises:
a step of placing the turbomachine in the installation zone of a bench, wherein the bench comprises:
an upstream sensor measuring the quantity of particles in the air upstream of the installation zone;
a downstream sensor measuring the quantity of particles in the air downstream of the installation zone; and
a calculation unit operating a difference between the quantity of downstream particles and the quantity of upstream particles; and
a step of operating the turbomachine during which the calculation unit monitors the difference between the quantity of downstream particles and the quantity of upstream particles.

16. The method according to claim 15, wherein the operating step consists of imposing an operating cycle with different engine speeds on the turbomachine and of drawing up, via the calculation unit, a correlation between the engine speeds and the quantity of particles emitted.

17. The method according to claim 15, wherein the calculation unit determines an average emission during the operating step.

18. A method for monitoring the condition of a turbomachine, wherein said method comprises repeating the method according to claim 15, at different times during the lifespan of the turbomachine.

19. The method according to claim 18, comprising repeating the method according to claim 15 for several comparable turbomachines, and recording the data of all the turbomachines in a common database.

20. The method according to claim 19, wherein a step of interpolation of the emissions measured during the lifespan of the turbomachines to determine a correlation between any given moment of the lifespan of a turbomachine and the average emission of pollutants produced at that given moment.

21. The method according to claim 20, wherein when a turbomachine has measured emissions which exceed by more than 20% the correlated average emission at that time of its lifespan, the turbomachine is overhauled, scrapped or is inspected to look for deterioration.

22. The method for monitoring the condition of a turbomachine, wherein said method comprises the method according to claim 15, and a step of analysis, diagnosis, or action to identify/control a turbomachine whose pollutant emissions would be higher than a regulatory threshold or a threshold established by correlation between the pollutant emissions and a deterioration of the turbomachine.
